(19) United States
(12) Patent Application Publication
(10) Pub. No.: US 2024/0362058 A1
(43) Pub. Date: Oct. 31, 2024

(54) SYSTEM, METHOD, AND COMPUTER PROGRAM FOR VIRTUAL COLLABORATION IN CLIENT COMMUNICATION

(71) Applicant: JPMorgan Chase Bank, N.A., New York, NY (US)

(72) Inventors: Shimona SHARMA, Ridgewood, NJ (US); Bhavin J SHUKLA, Piscataway, NJ (US); Hemathri BALAKRISHNAN, Frisco, TX (US); Prashant SHAH, Iselin, NJ (US); Sanjay R OZA, West Windsor, NJ (US); Romesh J NISSANGARATCHIE, Kendall Park, NJ (US)

(73) Assignee: JPMorgan Chase Bank, N.A., New York, NY (US)

(21) Appl. No.: 18/646,045

(22) Filed: Apr. 25, 2024

Related U.S. Application Data
(60) Provisional application No. 63/462,062, filed on Apr. 26, 2023.

(51) Int. Cl. G06F 9/455; G06F 21/62

(52) U.S. Cl. CPC G06F 9/45558; G06F 21/62

(57) ABSTRACT

Various methods, apparatuses/systems, and media for executing virtual collaboration are disclosed. A processor implements a virtual collaboration platform for providing a virtual branch experience to a plurality of users via seamless digitally enabled communication channels by leveraging features across a plurality of vendors; establishes a communication link between the virtual collaboration module and the digitally enabled communication channels via a communication interface; implements a first algorithm in a manner such that the virtual collaboration module is cloud native and supporting both multi-cloud and hybrid cloud models; implements a second algorithm in a manner such that the virtual collaboration module is configured to support an application seamlessly regardless of whether the application is deployed onto a desktop, or a mobile application and support multiple browsers; and executes real-time virtual collaboration including status of application health, metrics, alerts, and resource management.

### CROSS-REFERENCE TO RELATED APPLICATIONS

This application claims the benefit of priority from U.S. Provisional Patent Application No. 63/462,062, filed Apr. 26, 2023, which is herein incorporated by reference in its entirety.

### TECHNICAL FIELD

This disclosure generally relates to data processing, and, more particularly, to methods and apparatuses for implementing a platform, cloud, and language agnostic virtual collaboration module for providing a virtual branch experience to customers via seamless digitally enabled communication channels to virtually bank from any geo-location on a world class and secure platform.

### BACKGROUND

The developments described in this section are known to the inventors. However, unless otherwise indicated, it should not be assumed that any of the developments described in this section qualify as prior art merely by virtue of their inclusion in this section, or that those developments are known to a person of ordinary skill in the art.

Today, a wide variety of business functions are commonly supported by software applications and tools, i.e., business intelligence (BI) tools. For instance, software has been directed to data monitoring, performance analysis, project tracking, and competitive analysis, to name but a few. For any financial institution, the relationship between Advisor/Banker and client plays a pivotal role in advisor growth and defining the institution's wealth management future. Over several decades, banks have continually adapted the latest technology innovations by leveraging competitive financial technology solutions to redefine overall customer engagement. With the market disruption evolution happening in cloud native a Software-as-a-Service (SaaS) products, there appears to be a need to provide digital ecosystems for customer acquisition, engagement, and optimization.

Traditional methods of communication and information exchange such as phone calls, emails, and in person meetings can be inefficient, time-consuming, and prone to errors. At the same time, the growing generational gap between sales personnel supporting various lines of businesses and in particular Gen-Z clients not only makes it challenging for some sales personnel to understand and adjust as per needs of these younger generations of wealthy clients but weakens the client advisor relationship. Change appears to be nevertheless inevitable, and it is time for the wealth management industry to adapt the same.

### SUMMARY

To strengthen client/advisor relationships further in spite of a lack of in-person interactions, the need to shift focus towards virtual communication channels and collaboration platforms was inevitable. To address this issue, the instant disclosure implements an advanced platform to elevate the CRM platform to the next level. Building intelligent solutions to engage with clients in a seamless experience required futuristic technology innovations to be put in place.

The present disclosure generally relates to a system and method for facilitating efficient collaboration between personnel in the sales function and their clients/prospects through an improved SaaS platform, i.e., a platform, cloud, and language agnostic virtual collaboration module as disclosed herein. This virtual collaboration module may be configured to provide a new game changer platform for sales function business model by shifting entire customer journeys from physical branch networks to virtual personalized experiences creating unparalleled capacity a scale. This virtual collaboration module leverages the most relevant features to create a comprehensive offering that harmonizes digital and human capabilities to offer best-in-class services to clients in an efficient and effective way that were not possible by conventional tools.

For example, this virtual collaboration module enables seamless virtual communication, asynchronous chatting, document sharing, task management, integration with Customer Relationship Management (CRM) platform and analytics via generative artificial intelligence (AI), enhancing the efficiency and effectiveness of advisor-client interaction.

By providing a centralized and secure environment the virtual collaboration module fosters improved transparency, trust and engagement between sales personnel and clients, ultimately leading to better financial outcomes.

For example, the present disclosure, through one or more of its various aspects, embodiments, and/or specific features or sub-components, provides, among other features, various systems, servers, devices, methods, media, programs, and platforms for implementing a platform, cloud, and language agnostic virtual collaboration module for providing a virtual branch experience to customers via seamless digitally enabled communication channels to virtually bank from any geo-location on a world class and secure platform, but the disclosure is not limited thereto.

The virtual collaboration module, according to exemplary embodiments, implements an advanced platform for sales function business model by shifting entire customer journeys from physical branch networks to virtual personalized experiences creating unparalleled capacity and scale.

This enterprise-ready application with capabilities to support the collaboration needs of any platform in a truly PaaS (Product as a Service) fashion is an integral part of organization that allows advisers to communicate with their clients in a whole new way.

The virtual collaboration module as disclosed herein creates concierge-type services (virtual connect) through a high quality and fully customized user experience for video calling, screen share, interactive co-browsing, and virtual lounges to connect with the bank's advisors (employees) whether from home, branch, or contact center without delay, overcoming geographical distance and time zones challenges.

With the scale and reach the virtual collaboration module offers a superior competitive advantage in the market by assisting a wider population of sales personnel to connect with mass affluent users base via virtual meetings. Ease of use and higher reachability should elevate SAT (Security Administration Tool) scores among sales personnel, existing clients, and prospects.

According to exemplary embodiments, a method for executing virtual collaboration among a plurality of users by utilizing one or more processors along with allocated memory is disclosed. The method may include: implementing a virtual collaboration module configured for providing a virtual branch experience to a plurality of users via seamless digitally enabled communication channels by leveraging features across a plurality of vendors; establishing a communication link between the virtual collaboration module and the digitally enabled communication channels via a communication interface; implementing a first algorithm in a manner such that the virtual collaboration module is cloud native and supporting both multi-cloud and hybrid cloud models; implementing a second algorithm in a manner such that the virtual collaboration module is configured to support an application seamlessly regardless of whether the application is deployed onto a desktop, or a mobile application and support multiple browsers; executing real-time virtual collaboration including status of application health, metrics, alerts, and resource management; and implementing analytics tools and monitoring systems for tracking usage metrics, identifying performance bottlenecks, and detecting potential issues proactively.

According to exemplary embodiments, the method may further include: integrating the virtual collaboration module with a first platform that supports for customer relationship management software and applications focused on sales, customer service, marketing automation, e-commerce, analytics, and application development; integrating the virtual collaboration module with a second platform that supports concurrent videotelephony interactions among the plurality of users; and integrating the virtual collaboration module with a third platform that offers a comprehensive and fully integrated stack of cloud applications and cloud platform services.

According to exemplary embodiments, the hybrid cloud models may include both on-premises data centers and public cloud.

According to exemplary embodiments, the method may further include: hosting the virtual collaboration module onto a public cloud; implementing scalable cloud infrastructure, load balancing, and distributed databases; allowing access to the virtual collaboration module to a plurality of users; integrating the virtual collaboration module with the scalable cloud infrastructure, load balancing, and the distributed databases; and executing transactions, in response to integrating, among the plurality of users to process a plurality of documents and concurrent interactions.

According to exemplary embodiments, the method may further include: implementing an encryption algorithm for data transmission and storage associated with the transactions; and implementing a role-based access control algorithm in allowing the plurality of users to access the virtual collaboration module to protect user privacy and prevent unauthorized access.

According to exemplary embodiments, the method may further include: implementing the virtual collaboration module with a first platform configured for file transferring capabilities allowing users to attach documents to chats; and allowing all parties to keep digital records of their communication and documents; and integrating the virtual collaboration module with a cloud storage solutions or implementing a custom document repository for allowing indexing and utilizing search functionalities.

According to exemplary embodiments, in implementing the first algorithm, the method may further include: calling corresponding application programming interface to integrate the virtual collaboration module with both multi-cloud and hybrid cloud models; and in implementing the second algorithm, the method may further include: calling corresponding application programming interface to integrate the virtual collaboration module to multiple browsers.

According to exemplary embodiments, a system for executing virtual collaboration among a plurality of users is disclosed. The system may include: a processor; and a memory operatively connected to the processor via a communication interface, the memory storing computer readable instructions, when executed, may cause the processor to: implement a virtual collaboration module configured for providing a virtual branch experience to a plurality of users via seamless digitally enabled communication channels by leveraging features across a plurality of vendors; establish a communication link between the virtual collaboration module and the digitally enabled communication channels via a communication interface; implement a first algorithm in a manner such that the virtual collaboration module is cloud native and supporting both multi-cloud and hybrid cloud models; implement a second algorithm in a manner such that the virtual collaboration module is configured to support an application seamlessly regardless of whether the application is deployed onto a desktop, or a mobile application and support multiple browsers; execute real-time virtual collaboration including status of application health, metrics, alerts, and resource management; and implement analytics tools and monitor systems for tracking usage metrics, identifying performance bottlenecks, and detecting potential issues proactively.

According to exemplary embodiments, the processor may be further configured to: integrate the virtual collaboration module with a first platform that supports for customer relationship management software and applications focused on sales, customer service, marketing automation, e-commerce, analytics, and application development; integrate the virtual collaboration module with a second platform that supports concurrent videotelephony interactions among the plurality of users; and integrate the virtual collaboration module with a third platform that offers a comprehensive and fully integrated stack of cloud applications and cloud platform services.

According to exemplary embodiments, the processor may be further configured to: host the virtual collaboration module onto a public cloud; implement scalable cloud infrastructure, load balancing, and distributed databases; allow access to the virtual collaboration module to a plurality of users; integrate the virtual collaboration module with the scalable cloud infrastructure, load balancing, and the distributed databases; and execute transactions, in response to integrating, among the plurality of users to process a plurality of documents and concurrent interactions.

According to exemplary embodiments, the processor may be further configured to: implement an encryption algorithm for data transmission and storage associated with the transactions; and implement a role-based access control algorithm in allowing the plurality of users to access the virtual collaboration module to protect user privacy and prevent unauthorized access.

According to exemplary embodiments, the processor may be further configured to: implement the virtual collaboration module with a first platform configured for file transferring capabilities allowing users to attach documents to chats; and allow all parties to keep digital records of their communication and documents; and integrate the virtual collaboration module with a cloud storage solutions or implement a custom document repository for allowing indexing and utilizing search functionalities.

According to exemplary embodiments, in implementing the first algorithm, the processor may be further configured to: call corresponding application programming interface to integrate the virtual collaboration module with both multi-cloud and hybrid cloud models; and in implementing the second algorithm, the processor may be further configured to: call corresponding application programming interface to integrate the virtual collaboration module to multiple browsers.

According to exemplary embodiments, a non-transitory computer readable medium configured to store instructions for executing virtual collaboration among a plurality of users is disclosed. The instructions, when executed, may cause a processor to perform the following: implementing a virtual collaboration module configured for providing a virtual branch experience to a plurality of users via seamless digitally enabled communication channels by leveraging features across a plurality of vendors; establishing a communication link between the virtual collaboration module and the digitally enabled communication channels via a communication interface; implementing a first algorithm in a manner such that the virtual collaboration module is cloud native and supporting both multi-cloud and hybrid cloud models; implementing a second algorithm in a manner such that the virtual collaboration module is configured to support an application seamlessly regardless of whether the application is deployed onto a desktop, or a mobile application and support multiple browsers; executing real-time virtual collaboration including status of application health, metrics, alerts, and resource management; and implementing analytics tools and monitoring systems for tracking usage metrics, identifying performance bottlenecks, and detecting potential issues proactively.

According to exemplary embodiments, the instructions, when executed, may cause the processor to further perform the following: integrating the virtual collaboration module with a first platform that supports for customer relationship management software and applications focused on sales, customer service, marketing automation, e-commerce, analytics, and application development; integrating the virtual collaboration module with a second platform that supports concurrent videotelephony interactions among the plurality of users; and integrating the virtual collaboration module with a third platform that offers a comprehensive and fully integrated stack of cloud applications and cloud platform services.

According to exemplary embodiments, the instructions, when executed, may cause the processor to further perform the following: hosting the virtual collaboration module onto a public cloud; implementing scalable cloud infrastructure, load balancing, and distributed databases; allowing access to the virtual collaboration module to a plurality of users; integrating the virtual collaboration module with the scalable cloud infrastructure, load balancing, and the distributed databases; and executing transactions, in response to integrating, among the plurality of users to process a plurality of documents and concurrent interactions.

According to exemplary embodiments, the instructions, when executed, may cause the processor to further perform the following: implementing an encryption algorithm for data transmission and storage associated with the transactions; and implementing a role-based access control algorithm in allowing the plurality of users to access the virtual collaboration module to protect user privacy and prevent unauthorized access.

According to exemplary embodiments, the instructions, when executed, may cause the processor to further perform the following: implementing the virtual collaboration module with a first platform configured for file transferring capabilities allowing users to attach documents to chats; and allowing all parties to keep digital records of their communication and documents; and integrating the virtual collaboration module with a cloud storage solutions or implementing a custom document repository for allowing indexing and utilizing search functionalities.

According to exemplary embodiments, in implementing the first algorithm, the instructions, when executed, may cause the processor to further perform the following: calling corresponding application programming interface to integrate the virtual collaboration module with both multi-cloud and hybrid cloud models; and in implementing the second algorithm, the instructions, when executed, may cause the processor to further perform the following: calling corresponding application programming interface to integrate the virtual collaboration module to multiple browsers.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a platform, cloud, and language agnostic virtual collaboration module for executing virtual collaboration among a plurality of users via seamless digitally enabled communication channels in accordance with an exemplary embodiment.

FIG. 2 illustrates an exemplary diagram of a network environment with a platform, cloud, and language agnostic virtual collaboration device in accordance with an exemplary embodiment.

FIG. 3 illustrates a system diagram for implementing a platform, cloud, and language agnostic virtual collaboration device having a platform, cloud, and language agnostic virtual collaboration module in accordance with an exemplary embodiment.

FIG. 4 illustrates a system diagram for implementing a platform, cloud, and language agnostic virtual collaboration module of FIG. 3 in accordance with an exemplary embodiment.

FIG. 5 illustrates an exemplary integration architecture implemented by the platform, cloud, and language agnostic virtual collaboration module of FIG. 4 for executing virtual collaboration among a plurality of users via seamless digitally enabled communication channels in accordance with an exemplary embodiment.

FIG. 6 illustrates an exemplary flow chart implemented by the platform, cloud, and language agnostic virtual collaboration module of FIG. 4 for executing virtual collaboration among a plurality of users via seamless digitally enabled communication channels in accordance with an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

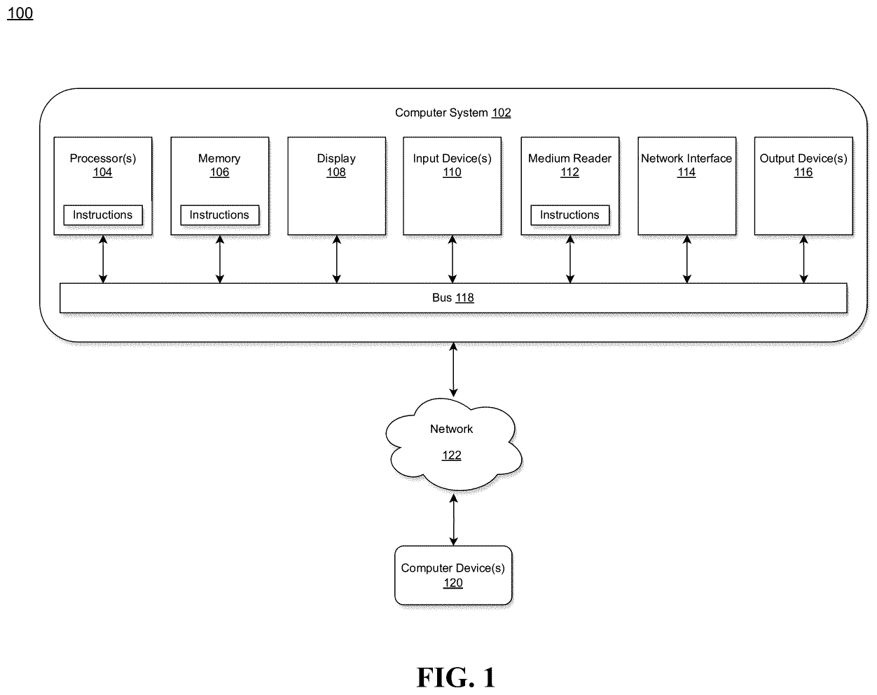

FIG. 1 is an exemplary system 100 for use in implementing a platform, cloud, and language agnostic virtual collaboration module that may be configured for executing virtual collaboration among a plurality of users via seamless digitally enabled communication channels in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

According to exemplary embodiments, the virtual collaboration module may be platform, language, database, and cloud agnostic that may allow for consistent easy orchestration and passing of data through various components to output a desired result. Since the disclosed process, according to exemplary embodiments, is platform, language, database, and cloud agnostic, the virtual collaboration module may be independently tuned or modified for optimal performance without affecting the configuration or data files. The configuration or data files, according to exemplary embodiments, may be written using JSON, but the disclosure is not limited thereto. For example, the configuration or data files may easily be extended to other readable file formats such as XML, YAML, etc., or any other configuration-based languages. For example, the data files may easily be extended to other files formats such as CSV, RDF, OWL, etc., or any other structured, semi-structured, or unstructured format.

In accordance with various embodiments of the present disclosure, the methods described herein may be implemented using a hardware computer system that executes software programs. Further, in an exemplary, non-limited embodiment, implementations can include distributed processing, component/object distributed processing, and an operation mode having parallel processing capabilities. Virtual computer system processing can be constructed to implement one or more of the methods or functionalities as described herein, and a processor described herein may be used to support a virtual processing environment.

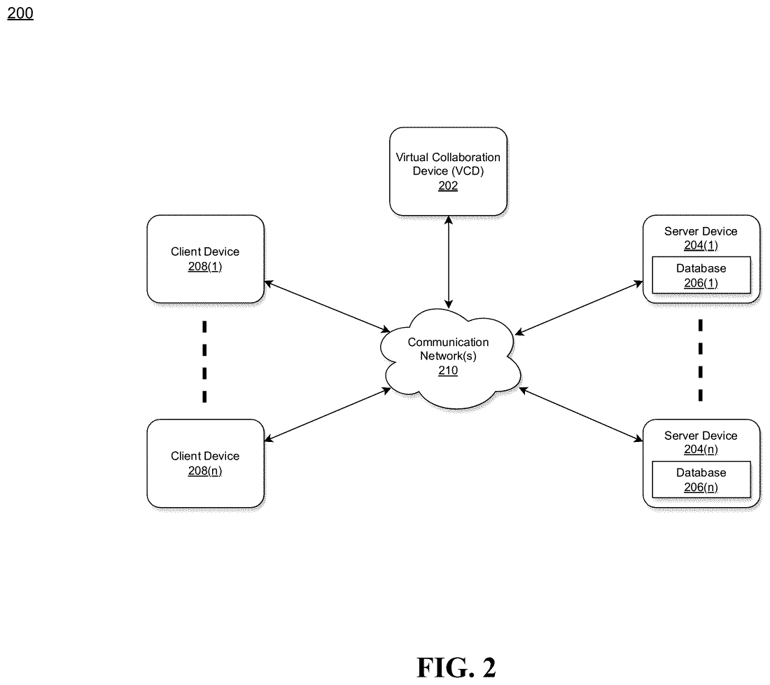

Referring to FIG. 2, a schematic of an exemplary network environment 200 for implementing a platform, cloud, and language agnostic virtual collaboration device (VCD) of the instant disclosure is illustrated.

According to exemplary embodiments, the above-described problems associated with conventional tools may be overcome by implementing an VCD 202 as illustrated in FIG. 2 that may be configured for executing virtual collaboration among a plurality of users via seamless digitally enabled communication channels, but the disclosure is not limited thereto. For example, according to exemplary embodiments, the above-described problems associated with conventional tools may be overcome by implementing an VCD 202 as illustrated in FIG. 2 that may be configured for facilitating efficient collaboration between sales personnel and their clients/prospects through an improved SaaS platform, i.e., a platform, cloud, and language agnostic virtual collaboration module as disclosed herein. This VCD 202 may be configured to provide a new game changer platform for sales function business model by shifting entire customer journeys from physical branch networks to virtual personalized experiences creating unparalleled capacity a scale. This VCD 202 leverages the most relevant features to create a comprehensive offering that harmonizes digital and human capabilities to offer best-in-class services to clients in an efficient and effective way that were not possible by conventional tools, but the disclosure is not limited thereto.

The VCD 202 may be the same or similar to the computer system 102 as described with respect to FIG. 1.

The VCD 202 may store one or more applications that can include executable instructions that, when executed by the VCD 202, cause the VCD 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the VCD 202 itself, may be located in virtual server(s) running in a cloud-based computing environment rather than being tied to one or more specific physical network computing devices. Also, the application(s) may be running in one or more virtual machines (VMs) executing on the VCD 202. Additionally, in one or more embodiments of this technology, virtual machine(s) running on the VCD 202 may be managed or supervised by a hypervisor.

In the network environment 200 of FIG. 2, the VCD 202 is coupled to a plurality of server devices 204(1)-204(n) that hosts a plurality of databases 206(1)-206(n), and also to a plurality of client devices 208(1)-208(n) via communication network(s) 210. A communication interface of the VCD 202, such as the network interface 114 of the computer system 102 of FIG. 1, operatively couples and communicates between the VCD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the VCD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 202 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The VCD 202 may be a standalone device or integrated with one or more other devices or apparatuses, such as one or more of the server devices 204(1)-204(n), for example. In one particular example, the VCD 202 may be hosted by one of the server devices 204(1)-204(n), and other arrangements are also possible. Moreover, one or more of the devices of the VCD 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the VCD 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data, but the disclosure is not limited thereto. For example, the database(s) 206(1)-206(n) may be a mainframe database, a log database that may produce programming for searching, monitoring, and analyzing machine-generated data via a web interface, etc., but the disclosure is not limited thereto. The database(s) 206(1)-206(n) may also include relational databases and NoSQL databases (key-value, column, document, graph, multi-model, etc.). Moreover, the VCD 202 may be configured to leverage any database protocol (i.e., Java Database Connectivity, Open Database Connectivity, etc.) and distributed file systems for reading/writing data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

According to exemplary embodiments, the client devices 208(1)-208(n) in this example may include any type of computing device that can facilitate the implementation of the VCD 202 that may efficiently provide a platform for implementing a platform, cloud, and language agnostic virtual collaboration module for executing virtual collaboration among a plurality of users via seamless digitally enabled communication channels, but the disclosure is not limited thereto. For example, according to exemplary embodiments, the client devices 208(1)-208(n) in this example may include any type of computing device that can facilitate the implementation of the VCD 202 that may efficiently provide a platform for implementing a platform, cloud, and language agnostic virtual collaboration module that that may be configured to facilitate efficient collaboration between sales personnel and their clients/prospects through an improved SaaS platform, i.e., a platform, cloud, and language agnostic virtual collaboration module as disclosed herein. This virtual collaboration module may be configured to provide a new game changer platform for sales function business model by shifting entire customer journeys from physical branch networks to virtual personalized experiences creating unparalleled capacity a scale. This virtual collaboration module leverages the most relevant features to create a comprehensive offering that harmonizes digital and human capabilities to offer best-in-class services to clients in an efficient and effective way that were not possible by conventional tools, but the disclosure is not limited thereto.

The client devices 208(1)-208(n) may run interface applications, such as standard web browsers or standalone client applications, which may provide an interface to communicate with the VCD 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the VCD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the VCD 202, the server devices 204(1)-204(n), or the client devices 208(1)-208(n), for example, may be configured to operate as virtual instances on the same physical machine. For example, one or more of the VCD 202, the server devices 204(1)-204(n), or the client devices 208(1)-208(n) may operate on the same physical device rather than as separate devices communicating through communication network(s) 210. Additionally, there may be more or fewer VCDs 202, server devices 204(1)-204(n), or client devices 208(1)-208(n) than illustrated in FIG. 2. According to exemplary embodiments, the VCD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

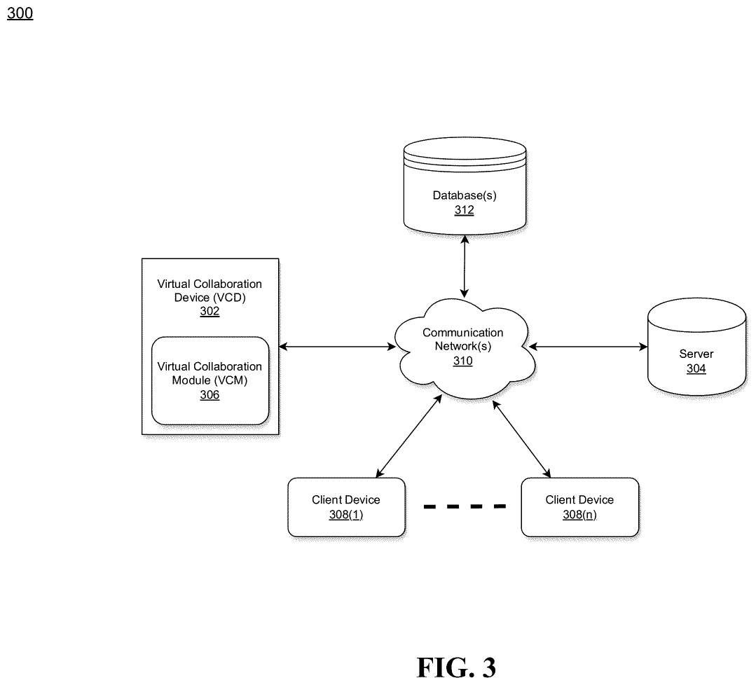

FIG. 3 illustrates a system diagram for implementing an VCD having a platform, cloud, and language agnostic virtual collaboration module (VCM) in accordance with an exemplary embodiment.

As illustrated in FIG. 3, the system 300 may include an VCD 302 within which an VCM 306 is embedded, a server 304, a database(s) 312, a plurality of client devices 308(1) 308 (n), and a communication network 310.

According to exemplary embodiments, the VCD 302 including the VCM 306 may be connected to the server 304, and the database(s) 312 via the communication network 310. The VCD 302 may also be connected to the plurality of client devices 308(1) . . . 308(n) via the communication network 310, but the disclosure is not limited thereto.

According to exemplary embodiment, the VCD 302 is described and shown in FIG. 3 as including the VCM 306, although it may include other rules, policies, modules, databases, or applications, for example. According to exemplary embodiments, the database(s) 312 may be configured to store ready to use modules written for each API for all environments. Although only one database is illustrated in FIG. 3, the disclosure is not limited thereto. Any number of desired databases may be utilized for use in the disclosed invention herein. The database(s) 312 may be a mainframe database, a log database that may produce programming for searching, monitoring, and analyzing machine-generated data via a web interface, etc., but the disclosure is not limited thereto. For example, the database(s) 312 may also include relational databases and NoSQL databases (key-value, column, document, graph, multi-model, etc.). Moreover, the VCM 306 may be configured to leverage any database protocol (i.e., Java Database Connectivity, Open Database Connectivity, etc.) and distributed file systems for reading/writing data.

According to exemplary embodiments, the VCM 306 may be configured to receive real-time feed of data from the plurality of client devices 308(1) . . . 308(n), and the database(s) 312 via the communication network 310. According to exemplary embodiments, the VCM 306 may be configured to utilize stream processing systems as the real-time feed. For example, the real-time feed(s) may be a stream processing system.

As will be described below, the VCM 306 may be configured to: implement a virtual collaboration module configured for providing a virtual branch experience to a plurality of users via seamless digitally enabled communication channels by leveraging features across a plurality of vendors; establish a communication link between the virtual collaboration module and the digitally enabled communication channels via a communication interface; implement a first algorithm in a manner such that the virtual collaboration module is cloud native and supporting both multi-cloud and hybrid cloud models; implement a second algorithm in a manner such that the virtual collaboration module is configured to support an application seamlessly regardless of whether the application is deployed onto a desktop, or a mobile application and support multiple browsers; execute real-time virtual collaboration including status of application health, metrics, alerts, and resource management; and implement analytics tools and monitor systems for tracking usage metrics, identifying performance bottlenecks, and detecting potential issues proactively, but the disclosure is not limited thereto.

The plurality of client devices 308(1) . . . 308(n) are illustrated as being in communication with the VCD 302. In this regard, the plurality of client devices 308(1) . . . 308(n) may be “clients” (e.g., customers) of the VCD 302 and are described herein as such. Nevertheless, it is to be known and understood that the plurality of client devices 308(1) . . . 308 (n) need not necessarily be “clients” of the VCD 302, or any entity described in association therewith herein. Any additional or alternative relationship may exist between either or both of the plurality of client devices 308(1) . . . 308(n) and the VCD 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. According to exemplary embodiments, the server 304 may be the same or equivalent to the server device 204 as illustrated in FIG. 2.

The process may be executed via the communication network 310, which may comprise plural networks as described above. For example, in an exemplary embodiment, one or more of the plurality of client devices 308(1) . . . 308(n) may communicate with the VCD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The VCD 302 may be the same or similar to the VCD 202 as described with respect to FIG. 2, including any features or combination of features described with respect thereto.

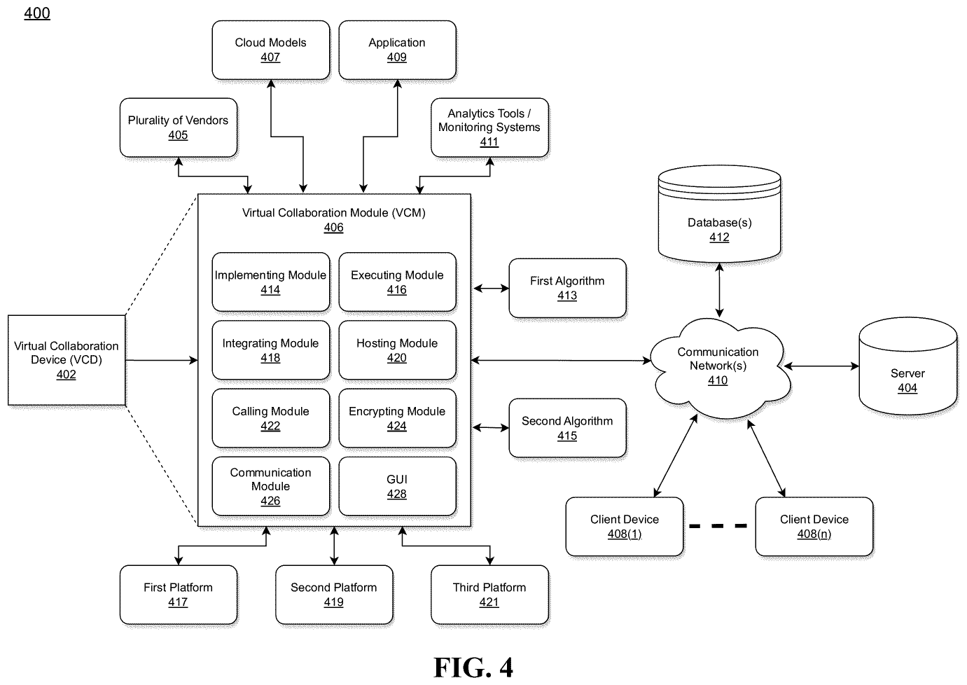

FIG. 4 illustrates a system diagram for implementing an VCM of FIG. 3 in accordance with an exemplary embodiment.

According to exemplary embodiments, the system 400 may include a platform, cloud, and language agnostic VCD 402 within which a platform, cloud, and language agnostic VCM 406 is embedded, a server 404, database(s) 412, and a communication network 410.

According to exemplary embodiments, the VCD 402 including the VCM 406 may be connected to the server 404, a plurality of vendors 405, cloud models 407, an application 409, a first platform 417, a second platform 419, a third platform 421, and the database(s) 412 via the communication network 410. The VCD 402 may also be connected to the plurality of client devices 408(1)-408(n) via the communication network 410, but the disclosure is not limited thereto. The VCM 406, the server 404, the plurality of client devices 408(1)-408(n), the database(s) 412, the communication network 410 as illustrated in FIG. 4 may be the same or similar to the VCM 306, the server 304, the plurality of client devices 308(1)-308(n), the database(s) 312, the communication network 310, respectively, as illustrated in FIG. 3.

According to exemplary embodiments, as illustrated in FIG. 4, the VCM 406 may include an implementing module 414, an executing module 416, an integrating module 418, a hosting module 420, a calling module 422, an encrypting module 424, a communication module 426, and a GUI 428. According to exemplary embodiments, interactions and data exchange among these modules included in the VCM 406 provide the advantageous effects of the disclosed invention. Functionalities of each module of FIG. 4 may be described in detail below with reference to FIGS. 4-6.

According to exemplary embodiments, each of the implementing module 414, executing module 416, integrating module 418, hosting module 420, calling module 422, encrypting module 424, and the communication module 426 of the VCM 406 may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies.

According to exemplary embodiments, each of the implementing module 414, executing module 416, integrating module 418, hosting module 420, calling module 422, encrypting module 424, and the communication module 426 of the VCM 406 may be implemented by microprocessors or similar, and may be programmed using software (e.g., microcode) to perform various functions discussed herein and may optionally be driven by firmware and/or software.

Alternatively, according to exemplary embodiments, each of the implementing module 414, executing module 416, integrating module 418, hosting module 420, calling module 422, encrypting module 424, and the communication module 426 of the VCM 406 may be implemented by dedicated hardware, or as a combination of dedicated hardware to perform some functions and a processor (e.g., one or more programmed microprocessors and associated circuitry) to perform other functions.

According to exemplary embodiments, each of the implementing module 414, executing module 416, integrating module 418, hosting module 420, calling module 422, encrypting module 424, and the communication module 426 of the VCM 406 may be called via corresponding API.

The process may be executed via the communication module 426 and the communication network 410, which may comprise plural networks as described above. For example, in an exemplary embodiment, the various components of the VCM 406 may communicate with the server 404, and the database(s) 412 via the communication module 426 and the communication network 410. Of course, these embodiments are merely exemplary and are not limiting or exhaustive.

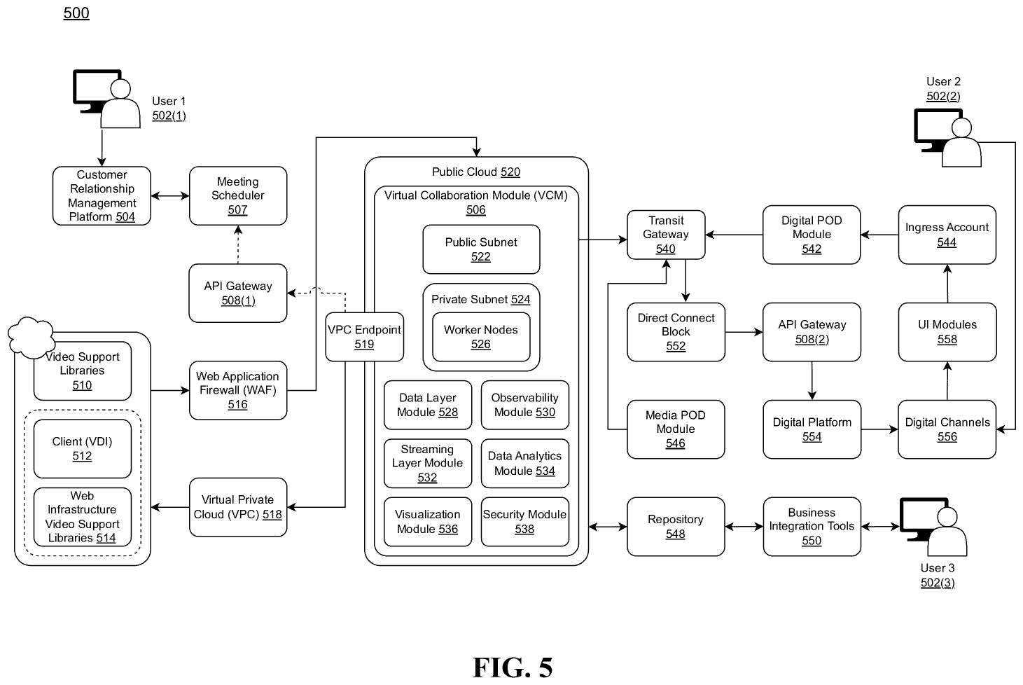

FIG. 5 illustrates an exemplary integration architecture 500 implemented by the platform, cloud, and language agnostic VCM 406 of FIG. 4 for executing virtual collaboration among a plurality of users via seamless digitally enabled communication channels in accordance with an exemplary embodiment.

To strengthen client/advisor relationships further in spite of a lack of in-person interactions, the need to shift focus towards virtual communication channels and collaboration platforms was inevitable. To address this issue, the instant disclosure implements an advanced platform to elevate the CRM platform to the next level. Building intelligent solutions to engage with clients in a seamless experience required futuristic technology innovations to be put in place.

The present disclosure generally relates to a system and method for facilitating efficient collaboration between sales personnel and their clients/prospects through an improved SaaS platform, i.e., a platform, cloud, and language agnostic VCM 406, 506 as disclosed herein. This VCM 406, 506 may be configured to provide a new game changer platform for sales function business model by shifting entire customer journeys from physical branch networks to virtual personalized experiences creating unparalleled capacity a scale (see, e.g., FIG. 5). This VCM 406, 506 leverages the most relevant features to create a comprehensive offering that harmonizes digital and human capabilities to offer best-in-class services to clients in an efficient and effective way that were not possible by conventional tools.

For example, this VCM 406, 506 enables seamless virtual communication, asynchronous chatting, document sharing, task management, integration with CRM platform and analytics via generative AI, enhancing the efficiency and effectiveness of advisor-client interaction.

By providing a centralized and secure environment the VCM 406, 506 fosters improved transparency, trust and engagement between advisors and clients, ultimately leading to better financial outcomes.

For example, the present disclosure, through one or more of its various aspects, embodiments, and/or specific features or sub-components, provides, among other features, various systems, servers, devices, methods, media, programs, and platforms for implementing a platform, cloud, and language agnostic VCM 406, 506 for providing a virtual branch experience to customers via seamless digitally enabled communication channels to virtually bank from any geo-location on a world class and secure platform, but the disclosure is not limited thereto.

The VCM 406, 506, according to exemplary embodiments, implements an advanced platform for sales function business model by shifting entire customer journeys from physical branch networks to virtual personalized experiences creating unparalleled capacity and scale.

This enterprise-ready application with capabilities to support the collaboration needs of any platform in a truly PaaS (Product as a Service) fashion is an integral part of organization that allows advisers to communicate with their clients in a whole new way.

The VCM 406, 506 as disclosed herein creates concierge-type services (virtual connect) through a high quality and fully customized user experience for video calling, screen share, interactive co-browsing, and virtual lounges to connect with the bank's advisors (employees) whether from home, branch, or contact center without delay, overcoming geographical distance and time zones challenges.

With the scale and reach the VCM 406, 506 offers a superior competitive advantage in the market by assisting a wider population of sales personnel to connect with mass affluent users base via virtual meetings. Ease of use and higher reachability should elevate SAT scores among advisors, existing clients, and prospects.

For example, as illustrated in FIG. 5, user 1 502(1) may be in communication with user 2 502(2) via a VCM 506 that is hosted on a public cloud 520. According to exemplary embodiments, user 1 502(1) may be financial advisors or bank manager, but the disclosure is not limited thereto. User 2 502(2) may be clients or customers of the bank or financial organizations.

As illustrated in FIG. 5, according to the exemplary integration architecture 500, VCM 506 may be operatively connected to video support libraries 510, a client VDI 512, and web infrastructure video support libraries 514. For example, the client VDI 512 may be a cloud-based desktop and app virtualization service that provides a multi-user experience. The user 1 502(1) may utilize a meeting scheduler 507 and a customer relationship management platform 505 to schedule a meeting with user 2 502(2). The customer relationship management platform 505 may be advisor central, client central, business central, auto implementation, etc., but the disclosure is not limited thereto.

For example, features implemented in the exemplary integration architecture 500 may include: multiparty collaboration experience; modern architecture, i.e., Octagon, Video Support Libraries; fully hosted on public cloud; integration with video conferencing platforms, etc.; line of business capabilities; low time-to-market capabilities, low integration complexity, etc., but the disclosure is not limited thereto.

Moreover, the VCM 406, 506 may be configured to provide multi-participants feature, next generation collaboration hub features, i.e., asynchronous chat, document sharing, annotation, etc., shift left automation features, data modernization features, resiliency and stability features, video banking features, etc., but the disclosure is not limited thereto.

With the scale and reach it offers, the solution provided by the VCM 406, 506 may provide a superior competitive advantage in the market enabling virtual branches concept having remote advisors, virtual bankers, and business relationship managers, i.e., huge savings for bank on branch infrastructure, employees can work remotely as virtual advisors/bankers (i.e., user 502(1) as illustrated in FIG. 5), reduce branch footprint and better management of customer wait times in branches, customers (i.e., user 502(2) as illustrated in FIG. 5) connect with their advisors (i.e., user 502(1) as illustrated in FIG. 5) at the comfort of their geo location and their devices. And if there is long wait time in branches, customers (i.e., user 502(2) as illustrated in FIG. 5) can leverage the VCM 406, 506(which may provide a virtual communication kiosk to connect with their virtual advisors (i.e., user 502(1) as illustrated in FIG. 5).

With this capability to mobilize talent and specialization irrespective of the organizational boundaries, the VCM 406, 506 may be configured to “bring the whole firm” to clients. Some of the advantages effected by the VCM 406, 506 may include the following.

Improved Efficiency: the VCM 406, 506 streamlines communication, document management, and task tracking via workflow, reducing administrative overhead, and saving time for both advisors (i.e., user 502(1) as illustrated in FIG. 5) and clients (i.e., user 502(2) as illustrated in FIG. 5).

Improved Collaboration: Enhanced channels of communication facilitate more frequent and meaningful interactions between clients and advisors, fostering stronger relationship and trusts.

Enhanced Collaboration: By providing centralized and secure environment the VCM 406, 506 fosters better collaboration, transparency, and trust between advisors and clients.

Better Decision-Making: Access to real-time data, analysis tools, AI enabled assistance and personalized insights empowers advisors to better assist their clients.

Regulatory Compliance: The VCM 406, 506 adheres to industry standards and regulations governing the handling of financial data, ensuring compliance with data privacy security requirements.

This VCM 406, 506 may be constructed with state-of-the-art technology and may incorporate sound architectural principles to ensure modularity and scalability (see, e.g., FIG. 5). Offering a best-in-class user experience, it boasts top tier security seamlessly integrated with any banking application. At the heart of collaboration lies communication between clients and advisors. According to exemplary embodiments, the VCM 406, 506 may implement methods of engagement by scheduling video/virtual meetings. As illustrated in FIG. 5, the user 1 502(1) (i.e., advisors/bankers) may utilize a meeting scheduler 507 and a customer relationship management platform 505 to schedule a meeting with user 2 502(2) (i.e., clients/customers). The customer relationship management platform 505 may be advisor central, client central, business central, auto implementation, etc., but the disclosure is not limited thereto.

The engagement process may include four key stages: purpose engagement, preparation for upcoming meeting, during meeting, and post meeting, but the disclosure is not limited thereto.

Purpose of engagement may include: referral by another advisor/banker; engaging the customer for new business opportunities, such as opening a new account or regular quarterly/monthly check-in; chat communication between advisor/bankers regarding; streamlining and simplifying the process of scheduling meetings with customers, etc., but the disclosure is not limited thereto.

Preparation for the upcoming meeting may include: prepare customer for the upcoming meeting with required forms/documents; prepare advisors based on previous meetings by providing their automated meeting notes till date, etc., but the disclosure is not limited thereto.

During meeting may include the following, but the disclosure is not limited thereto.

Enable “Platform-Admit” functionality: When participants join the meeting, they enter a session where they await the arrival of the host. During this time, participants are unable to see each other adhering to legal risk compliance until the host admits them to the main virtual/video meeting after validating each participant.

Enable advertisement functionality: The meeting participants are in the queuing session, where they listen to bank commercials tailored to their recent query, determined by generative AI algorithms.

The AI enabled assistant, seamlessly integrated into the VCM 406, 506, listens to the discussion and offers a real-time recommendation as the conversation unfolds.

Enable real-time translator—these solutions enable individuals and businesses to communicate seamlessly with advisor/banker across languages, opening new opportunities and enhancing cross-cultural understanding.

Post Meeting may include the following, but the disclosure is not limited thereto: the AI powered assistant software reviews complete meeting recordings to generate meeting notes and utilize models for organizing tasks and follow-ups. It also performs customer sentiment analysis, which may aid branch managers in faster resolution. Additionally, the software assesses the video quality to determine the mean opinion score, with all data subsequently stored in the CRM platform for future use.

For example, as illustrated in FIG. 5, API gateway 507 may be utilized by the meeting scheduler 507 for scheduling a meeting between user 1 502(1) (advisor/banker) and user 2 502(2) (clients/customers). The VPC endpoint 519 may provide the API gateway 508(1). Data from the video support libraries 510 may be operative connected to the VCM 506 via web application firewall 516. Data from the VPC endpoint 519 may flow to the video support libraries 510, client (VDI) 512, web infrastructure video support libraries 514 via virtual private cloud 518. The web application firewall 516 may be a web application firewall that helps protect web applications from attacks by allowing a user to configure rules that allow, block, or monitor (count) web requests based on conditions that the user defines. VPC may be an on-demand configurable pool of shared resources allocated within a public cloud environment, providing a certain level of isolation between the different organizations using the resources.

Scalability: The VCM 406, 506 is configured to handle a potentially large number of users, documents, and concurrent interactions. Scalability may be achieved using scalable cloud infrastructure, load balancing, and distributed databases as disclosed herein.

Security: Security is paramount when dealing with sensitive documents and communication data. Implementing encryption for data transmission and storage, role-based access controls, and regular security audits are essential to protect user privacy and prevent unauthorized access.

Document Management: the VCM 406, 506 providing file transferring capabilities allow advisors to attach documents to chats; additionally, both parties can keep digital records of their communication and financial documents, preventing information from getting lost. Integrating with cloud storage solutions or implementing a custom document repository, i.e., repository 548 as illustrated in FIG. 5, with indexing and search functionalities can enhance document management efficiency.

Integration with CRM systems: Seamless integration with CRM systems allows for the synchronization of customer data, activities, and interactions between our virtual (collaboration) platform and CRM's. APIs provided by CRM vendors or implementing custom integration solutions can facilitate this data exchange.

User Experience: the VCM 406, 506, Designing an intuitive and user-friendly interface is crucial for encouraging adoption and engagement.

Cross-platform Compatibility: The platform should be accessible across various devices and operating system to accommodate the user's preferences and work environments. Developing responsive web applications and native mobile apps with consistent user interfaces ensures a seamless experience across platforms.

Testing strategy: Given that the application 409 should work seamlessly for customers deployed against all platforms i.e., desktop or mobile app and cross browsers, one needs to make sure that product has robust testing strategy in place. Exemplary testing may include: functional testing, stress testing, automation testing, load testing, security testing, accessibility testing, usability testing, GUI testing, compatibility testing, i.e., device compatibility testing, platform compatibility testing, browser compatibility testing, etc., but the disclosure is not limited thereto.

For example, audio/video automation testing may include measuring audio/video transmission quality when customers (i.e., user 502(2)) joins the meeting from different desktop or mobile devices. For example, customer join flow may include selecting a device or a browser via an organizational website (i.e., bank.com) and customer joins the VCM 406, 506. Advisor (i.e., user 502(1)) join flow may include calling API in cloud POD (i.e., API gateway 508(1) as illustrated in FIG. 5) and advisor joins the VCM 406, 506 and publishes pre-recorded video to video monitoring session. This testing may also include extracting customer view and compare this video with original published video and then comparing quality of original and extracted video (i.e., compare frames, any missing frames, any stuck frames, brightness, colorfulness contrast, compare Mean Opinion Score (MOS), etc., but the disclosure is not limited thereto).

The VCM 406, 506 may be configured for reporting and telemetry and analytics and monitoring capabilities. As illustrated in the exemplary integration architecture 500, the VCM 506 may include a public subnetwork 522, private subnetwork 524 that may include worker nodes 526. The VCM 506 may also include a data layer module 528, observability module 530, streaming module 532, data analytics module 534, visualization module 536 by utilizing the GUI 428 as illustrated in FIG. 4, and a security module 538. Data from the VCM 506 may flow to transit gateway 540 which may receive data from the digital POD module 542 and the media POD module 546. The digital POD module 542 may receive data from ingress account 544 which may receive data from UI modules 558. Data from the transit gateway 540 may also flow to a direct connect block 552 which may output data to an API gateway 508(2). Data from the API gateway 508(2) may flow to the digital platform 554. And data from the digital platform 554 may flow to the digital channels 556. The user 2 502(2) may communicate with the user 1 502(1) via the digital channels 556.

According to exemplary embodiments, the digital POD module 542 is a model centered on building small, independent teams of IT specialists with diverse competencies who work collaboratively to deliver a defined product.

According to exemplary embodiments, the media POD module 546 provides web design, development, digital marketing, and much more to optimize your digital ecosystem.

According to exemplary embodiments, the repository 548 may be a repository for centrally storing large amounts of data in its raw form, including structured, unstructured, and semi-structured data. For example, a database stores data. However, the repository 548 may be a special class of database which is designed to store meta-data, that is, data that describes other data.

As illustrated in FIG. 5, the repository 548 may be operatively connected to both the VCM 506 and a plurality of business integration tools 550. The business integration tools 550 may be utilized by user 3 502(3) (i.e., business analysts).

For example, real-time statistics of end customers (i.e., user 502(1)) to bankers/advisors (i.e., user 502(1)) provide timely assistance. Comprehensive monitoring solution (AWS/on-prem) on a single dashboard may provide real-time status of application health, metrics, alerting and resource management.

Implementing analytics tools and monitoring systems (i.e., business integration tools 550, data analytics module 534, observability module 530, streaming layer module 532, visualization module 536, data layer module 528, etc.) by the VCM 506 allows for tracking usage metrics, identifying performance bottlenecks, and detecting potential issues proactively.

With better user experience in mind, there is a need to develop mobile native apps instead of web apps. According to exemplary embodiments, the integration architecture 500 provides companion app-immersive client experience, consistent for iOS and Android users thereby supporting multi-auth model for mobile users on digital.

By addressing these technical design considerations, the VCM 406, 506 may be configured to execute a robust and reliable solution that meets the needs of advisors and clients for efficient communication and collaboration.

For example, by referring back to FIGS. 4 and 5, the implementing module 414 may be configured to implement a VCM 406, 506 configured for providing a virtual branch experience to a plurality of users (users 502(1), 502(2), 502(3)) via seamless digitally enabled communication channels by leveraging features across a plurality of vendors. The communication module 426 may be configured to establish a communication link between the VCM 406, 506 and the digitally enabled communication channels via a communication interface (i.e., GUI 428). The implementing module 414 may be further configured to implement a first algorithm 413 in a manner such that the VCM 406, 506 is cloud native and supporting both multi-cloud and hybrid cloud models. The implementing module 414 may be further configured to implement a second algorithm 415 in a manner such that the VCM 406, 506 is configured to support an application 409 seamlessly regardless of whether the application 409 is deployed onto a desktop, or a mobile application and support multiple browsers.

According to exemplary embodiments, in implementing the first algorithm 413, the calling module 422 may be configured to call corresponding application programming interface to integrate the VCM 406, 506 with both multi-cloud and hybrid cloud models; and in implementing the second algorithm 415, the calling module 422 may be further configured to call corresponding application programming interface to integrate the VCM 406, 506 to multiple browsers.

According to exemplary embodiments, the executing module 416 may be configured to execute real-time virtual collaboration including status of application health, metrics, alerts, and resource management; and implement analytics tools and monitor systems for tracking usage metrics, identifying performance bottlenecks, and detecting potential issues proactively.

According to exemplary embodiments, the integrating module 418 may be configured to: integrate the VCM 406, 506 with a first platform 417 that supports for customer relationship management software and applications focused on sales, customer service, marketing automation, e-commerce, analytics, and application development; integrate the VCM 406, 506 with a second platform 419 that supports concurrent videotelephony interactions among the plurality of users; and integrate the VCM 406, 506 with a third platform 421 that offers a comprehensive and fully integrated stack of cloud applications and cloud platform services.

According to exemplary embodiments, the hosting module may be configured to host the VCM 406, 506 onto a public cloud 520. The implementing module 414 may be further configured to implement scalable cloud infrastructure, load balancing, and distributed databases and allow access to the VCM 406, 506 to the plurality of users. The integrating module 418 may be configured to integrate the VCM 406, 506 with the scalable cloud infrastructure, load balancing, and the distributed databases. And the executing module 416 may be configured to execute transactions, in response to integrating, among the plurality of users to process a plurality of documents and concurrent interactions.

According to exemplary embodiments, the implementing module 414 may be further configured to: implement an encryption algorithm provided by the encrypting module 424 for data transmission and storage associated with the transactions; and implement a role-based access control algorithm in allowing the plurality of users to access the VCM 406, 506 to protect user privacy and prevent unauthorized access.

According to exemplary embodiments, the implementing module 414 may be further configured to implement the VCM 406, 506 with a platform configured for file transferring capabilities allowing users to attach documents to chats; and allow all parties to keep digital records of their communication and documents; and integrate the VCM 406, 506 with a cloud storage solutions or implement a custom document repository (i.e., repository 548) for allowing indexing and utilizing search functionalities.

Nothing can replace face-to-face interactions; however, video conferencing implemented by the VCM 406, 506 offers a lot of benefits, especially for clients who don't live close to a physical office or need a few more opportunities to check in.

With the right tools as illustrated in FIGS. 4 and 5, one can let clients make notes on a promotion or presentation, add information to shared documents, and make real-time adjustments to their portfolios. What might have been a confusing email in the past can now be a working session to help a client make an urgent change by utilizing the VCM 406, 506.

Moreover, the VCM 406 and 506 implements generative AI to revolutionize customer experience. For example, the generative AI as implemented herein may assist sales personnel by delivering personalized, data driven insights about their customers which internally could help them in building relationships with clients, providing them with support and guidance they need to achieve their goals.

Exemplary use-cases provided by the VCM 406, 506 may include the following but the disclosure is not limited thereto.

Personalized offers: by utilizing the VCM 406, 506, users can make individual offers with images and natural language.

Wealth planning: by utilizing the VCM 406, 506, users may be able to simulate various client needs and economic scenarios so sales personnel can provide situation specific financial recommendation.

Analyze customer feedback: by utilizing the VCM 406, 506, users may be able to analyze surveys to identify common themes and opportunities for improvements. This could result in boosting customer retention.

Create customer segment-driven experiences: by analyzing and understanding how different customer segments interact with an organization's brand, one can create, by utilizing the VCM 406, 506, more effective experience quickly and accurately tailored as per customer behavior, preferences, and demographics.

Behavioral Targeting: utilize data and analytics tools as disclosed in FIGS. 4 and 5 to understand client's preferences and needs, so one can tailor marketing and communication for better engagement.

Futuristic capabilities like Referral Program, sharing documents, whiteboarding, offline video messaging, broadcasting provided by the VCM 406, 506 may enhance and provide better collaboration between banker and advisors.

Offline Video Messaging: advisor/client can collaborate offline via video messages by utilizing the VCM 406, 506.

Referral Program: the VCM 406, 506 may be configured for better collaboration (communication channel) between banker and advisors.

By utilizing the VCM 406, 506, users can encourage existing clients to refer to their friends and family by offering incentives, such as a discount on their next consultation or a gift card. This may not only help grow the advisor's client base but also improve customer satisfaction. With better communication channel among field personnel staff, one could achieve: speed to close; real time communication; auditing of communication; learning/transparency, etc., but the disclosure is not limited thereto.

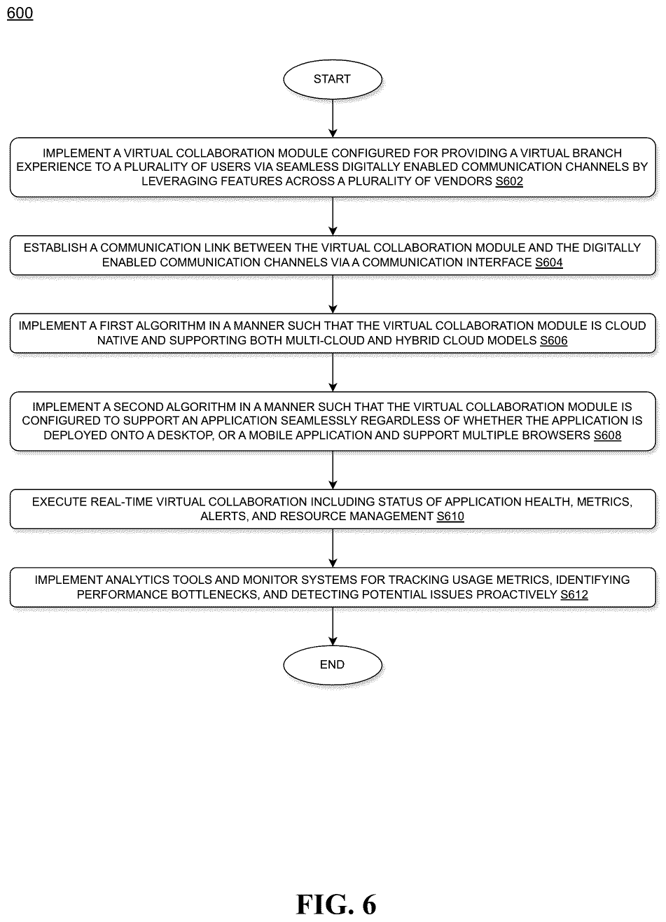

FIG. 6 illustrates an exemplary flow chart 600 implemented by the VCM 406 of FIG. 4 for executing virtual collaboration among a plurality of users via seamless digitally enabled communication channels in accordance with an exemplary embodiment. It will be appreciated that the illustrated process 600 and associated steps may be performed in a different order, with illustrated steps omitted, with additional steps added, or with a combination of reordered, combined, omitted, or additional steps.

As illustrated in FIG. 6, at step S602, the process 600 may include implementing a virtual collaboration module configured for providing a virtual experience to a plurality of users via seamless digitally enabled communication channels by leveraging features across a plurality of vendors.

At step S604, the process 600 may include establishing a communication link between the virtual collaboration module and the digitally enabled communication channels via a communication interface.

At step S606, the process 600 may include implementing a first algorithm in a manner such that the virtual collaboration module is cloud native and supporting both multi-cloud and hybrid cloud models.

At step S608, the process 600 may include implementing a second algorithm in a manner such that the virtual collaboration module is configured to support an application seamlessly regardless of whether the application is deployed onto a desktop, or a mobile application and support multiple browsers.

At step S610, the process 600 may include executing real-time virtual collaboration including status of application health, metrics, alerts, and resource management.

At step S612, the process 600 may include implementing analytics tools and monitoring systems for tracking usage metrics, identifying performance bottlenecks, and detecting potential issues proactively.

According to exemplary embodiments, the method may further include: integrating the virtual collaboration module with a first platform that supports for customer relationship management software and applications focused on sales, customer service, marketing automation, e-commerce, analytics, and application development; integrating the virtual collaboration module with a second platform that supports concurrent videotelephony interactions among the plurality of users; and integrating the virtual collaboration module with a third platform that offers a comprehensive and fully integrated stack of cloud applications and cloud platform services.

According to exemplary embodiments, the hybrid cloud models may include both on-premises data centers and public cloud.

According to exemplary embodiments, the process 600 may further include: hosting the virtual collaboration module onto a public cloud; implementing scalable cloud infrastructure, load balancing, and distributed databases; allowing access to the virtual collaboration module to a plurality of users; integrating the virtual collaboration module with the scalable cloud infrastructure, load balancing, and the distributed databases; and executing transactions, in response to integrating, among the plurality of users to process a plurality of documents and concurrent interactions.

According to exemplary embodiments, the process 600 may further include: implementing an encryption algorithm for data transmission and storage associated with the transactions; and implementing a role-based access control algorithm in allowing the plurality of users to access the virtual collaboration module to protect user privacy and prevent unauthorized access.

According to exemplary embodiments, the process 600 may further include: implementing the virtual collaboration module with a first platform configured for file transferring capabilities allowing users to attach documents to chats; and allowing all parties to keep digital records of their communication and documents; and integrating the virtual collaboration module with a cloud storage solutions or implementing a custom document repository for allowing indexing and utilizing search functionalities.

According to exemplary embodiments, in implementing the first algorithm, the process 600 may further include: calling corresponding application programming interface to integrate the virtual collaboration module with both multi-cloud and hybrid cloud models; and in implementing the second algorithm, the process 600 may further include: calling corresponding application programming interface to integrate the virtual collaboration module to multiple browsers.

According to exemplary embodiments, the VCD 402 may include a memory (e.g., a memory 106 as illustrated in FIG. 1) which may be a non-transitory computer readable medium that may be configured to store instructions for implementing an VCM 406 for executing virtual collaboration among a plurality of users as disclosed herein. The VCD 402 may also include a medium reader (e.g., a medium reader 112 as illustrated in FIG. 1) which may be configured to read any one or more sets of instructions, e.g., software, from any of the memories described herein. The instructions, when executed by a processor embedded within the VCM 406 or within the VCD 402, may be used to perform one or more of the methods and processes as described herein. In a particular embodiment, the instructions may reside completely, or at least partially, within the memory 106, the medium reader 112, and/or the processor 104(see FIG. 1) during execution by the VCD 402.

According to exemplary embodiments, the instructions, when executed, may cause a processor embedded within the VCM 406, 506 or the VCD 402 to perform the following: implementing a virtual collaboration module configured for providing a virtual branch experience to a plurality of users via seamless digitally enabled communication channels by leveraging features across a plurality of vendors; establishing a communication link between the virtual collaboration module and the digitally enabled communication channels via a communication interface; implementing a first algorithm in a manner such that the virtual collaboration module is cloud native and supporting both multi-cloud and hybrid cloud models; implementing a second algorithm in a manner such that the virtual collaboration module is configured to support an application seamlessly regardless of whether the application is deployed onto a desktop, or a mobile application and support multiple browsers; executing real-time virtual collaboration including status of application health, metrics, alerts, and resource management; and implementing analytics tools and monitoring systems for tracking usage metrics, identifying performance bottlenecks, and detecting potential issues proactively, but the disclosure is not limited thereto. According to exemplary embodiments, the processor may be the same or similar to the processor 104 as illustrated in FIG. 1 or the processor embedded within VCD 202, VCD 302, VCD 402, and VCM 406, 506.

According to exemplary embodiments, the instructions, when executed, may cause the processor 104 to further perform the following: integrating the virtual collaboration module with a first platform that supports for customer relationship management software and applications focused on sales, customer service, marketing automation, e-commerce, analytics, and application development; integrating the virtual collaboration module with a second platform that supports concurrent videotelephony interactions among the plurality of users; and integrating the virtual collaboration module with a third platform that offers a comprehensive and fully integrated stack of cloud applications and cloud platform services.

According to exemplary embodiments, the instructions, when executed, may cause the processor 104 to further perform the following: hosting the virtual collaboration module onto a public cloud; implementing scalable cloud infrastructure, load balancing, and distributed databases; allowing access to the virtual collaboration module to a plurality of users; integrating the virtual collaboration module with the scalable cloud infrastructure, load balancing, and the distributed databases; and executing transactions, in response to integrating, among the plurality of users to process a plurality of documents and concurrent interactions.

According to exemplary embodiments, the instructions, when executed, may cause the processor 104 to further perform the following: implementing an encryption algorithm for data transmission and storage associated with the transactions; and implementing a role-based access control algorithm in allowing the plurality of users to access the virtual collaboration module to protect user privacy and prevent unauthorized access.

According to exemplary embodiments, the instructions, when executed, may cause the processor 104 to further perform the following: implementing the virtual collaboration module with a first platform configured for file transferring capabilities allowing users to attach documents to chats; and allowing all parties to keep digital records of their communication and documents; and integrating the virtual collaboration module with a cloud storage solutions or implementing a custom document repository for allowing indexing and utilizing search functionalities.

According to exemplary embodiments, in implementing the first algorithm, the instructions, when executed, may cause the processor 104 to further perform the following: calling corresponding application programming interface to integrate the virtual collaboration module with both multi-cloud and hybrid cloud models; and in implementing the second algorithm, the instructions, when executed, may cause the processor to further perform the following: calling corresponding application programming interface to integrate the virtual collaboration module to multiple browsers.

According to exemplary embodiments as disclosed above in FIGS. 1-6, technical improvements effected by the instant disclosure may include a platform for executing virtual collaboration among a plurality of users via seamless digitally enabled communication channels, but the disclosure is not limited thereto.

For example, according to exemplary embodiments as disclosed above in FIGS. 1-6, technical improvements effected by the instant disclosure may include a platform for implementing a platform, cloud, and language agnostic virtual collaboration module that may be configured to implements an advanced platform for sales function business model by shifting entire customer journeys from physical branch networks to virtual personalized experiences creating unparalleled capacity and scale. This enterprise-ready application with capabilities to support the collaboration needs of any platform in a truly PaaS fashion is an integral part of organization that allows advisers to communicate with their clients in a whole new way.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for executing virtual collaboration among a plurality of users by utilizing one or more processors along with allocated memory, the method comprising:
implementing a virtual collaboration module configured for providing a virtual experience to a plurality of users via seamless digitally enabled communication channels by leveraging features across a plurality of vendors;
establishing a communication link between the virtual collaboration module and the digitally enabled communication channels via a communication interface;
implementing a first algorithm in a manner such that the virtual collaboration module is cloud native and supporting both multi-cloud and hybrid cloud models;
implementing a second algorithm in a manner such that the virtual collaboration module is configured to support an application seamlessly regardless of whether the application is deployed onto a desktop, or a mobile application and support multiple browsers;
executing real-time virtual collaboration including status of application health, metrics, alerts, and resource management; and
implementing analytics tools and monitoring systems for tracking usage metrics, identifying performance bottlenecks, and detecting potential issues proactively.

2. The method according to claim 1, further comprising:
integrating the virtual collaboration module with a first platform that supports for customer relationship management software and applications focused on sales, customer service, marketing automation, e-commerce, analytics, and application development;
integrating the virtual collaboration module with a second platform that supports concurrent videotelephony interactions among the plurality of users; and
integrating the virtual collaboration module with a third platform that offers a comprehensive and fully integrated stack of cloud applications and cloud platform services.

3. The method according to claim 1, wherein the hybrid cloud models include both on-premises data centers and public cloud.

4. The method according to claim 1, further comprising:
hosting the virtual collaboration module onto a public cloud;
implementing scalable cloud infrastructure, load balancing, and distributed databases;
allowing access to the virtual collaboration module to a plurality of users;
integrating the virtual collaboration module with the scalable cloud infrastructure, load balancing, and the distributed databases; and
executing transactions, in response to integrating, among the plurality of users to process a plurality of documents and concurrent interactions.

5. The method according to claim 4, further comprising:
implementing an encryption algorithm for data transmission and storage associated with the transactions; and
implementing a role-based access control algorithm in allowing the plurality of users to access the virtual collaboration module to protect user privacy and prevent unauthorized access.

6. The method according to claim 1, further comprising:
implementing the virtual collaboration module with a first platform configured for file transferring capabilities allowing users to attach documents to chats; and allowing all parties to keep digital records of their communication and documents; and
integrating the virtual collaboration module with a cloud storage solutions or implementing a custom document repository for allowing indexing and utilizing search functionalities.

7. The method according to claim 1, wherein in implementing the first algorithm, the method further comprising: calling corresponding application programming interface to integrate the virtual collaboration module with both multi-cloud and hybrid cloud models; and
wherein in implementing the second algorithm, the method further comprising: calling corresponding application programming interface to integrate the virtual collaboration module to multiple browsers.

8. A system for executing virtual collaboration among a plurality of users, the system comprising:
a processor; and
a memory operatively connected to the processor via a communication interface, the memory storing computer readable instructions, when executed, causes the processor to:
implement a virtual collaboration module configured for providing a virtual experience to a plurality of users via seamless digitally enabled communication channels by leveraging features across a plurality of vendors;
establish a communication link between the virtual collaboration module and the digitally enabled communication channels via a communication interface;
implement a first algorithm in a manner such that the virtual collaboration module is cloud native and supporting both multi-cloud and hybrid cloud models;
implement a second algorithm in a manner such that the virtual collaboration module is configured to support an application seamlessly regardless of whether the application is deployed onto a desktop, or a mobile application and support multiple browsers;
execute real-time virtual collaboration including status of application health, metrics, alerts, and resource management; and
implement analytics tools and monitor systems for tracking usage metrics, identifying performance bottlenecks, and detecting potential issues proactively.

9. The system according to claim 8, wherein the processor is further configured to:
integrate the virtual collaboration module with a first platform that supports for customer relationship management software and applications focused on sales, customer service, marketing automation, e-commerce, analytics, and application development;
integrate the virtual collaboration module with a second platform that supports concurrent videotelephony interactions among the plurality of users; and
integrate the virtual collaboration module with a third platform that offers a comprehensive and fully integrated stack of cloud applications and cloud platform services.

10. The system according to claim 8, wherein the hybrid cloud models include both on-premises data centers and public cloud.

11. The system according to claim 8, wherein the processor is further configured to:
host the virtual collaboration module onto a public cloud;
implement scalable cloud infrastructure, load balancing, and distributed databases;
allow access to the virtual collaboration module to a plurality of users;
integrate the virtual collaboration module with the scalable cloud infrastructure, load balancing, and the distributed databases; and
execute transactions, in response to integrating, among the plurality of users to process a plurality of documents and concurrent interactions.

12. The system according to claim 11, wherein the processor is further configured to:
implement an encryption algorithm for data transmission and storage associated with the transactions; and
implement a role-based access control algorithm in allowing the plurality of users to access the virtual collaboration module to protect user privacy and prevent unauthorized access.

13. The system according to claim 8, wherein the processor is further configured to:
implement the virtual collaboration module with a first platform configured for file transferring capabilities allowing users to attach documents to chats; and allow all parties to keep digital records of their communication and documents; and
integrate the virtual collaboration module with a cloud storage solutions or implement a custom document repository for allowing indexing and utilizing search functionalities.

14. The system according to claim 8, in implementing the first algorithm, the processor is further configured to: call corresponding application programming interface to integrate the virtual collaboration module with both multi-cloud and hybrid cloud models; and
in implementing the second algorithm, the processor is further configured to: call corresponding application programming interface to integrate the virtual collaboration module to multiple browsers.

15. A non-transitory computer readable medium configured to store instructions for executing virtual collaboration among a plurality of users, the instructions, when executed, cause a processor to perform the following:
implementing a virtual collaboration module configured for providing a virtual experience to a plurality of users via seamless digitally enabled communication channels by leveraging features across a plurality of vendors;
establishing a communication link between the virtual collaboration module and the digitally enabled communication channels via a communication interface;
implementing a first algorithm in a manner such that the virtual collaboration module is cloud native and supporting both multi-cloud and hybrid cloud models;
implementing a second algorithm in a manner such that the virtual collaboration module is configured to support an application seamlessly regardless of whether the application is deployed onto a desktop, or a mobile application and support multiple browsers;
executing real-time virtual collaboration including status of application health, metrics, alerts, and resource management; and
implementing analytics tools and monitoring systems for tracking usage metrics, identifying performance bottlenecks, and detecting potential issues proactively.

16. The non-transitory computer readable medium according to claim 15, wherein the instructions, when executed, cause the processor to further perform the following:
integrating the virtual collaboration module with a first platform that supports for customer relationship management software and applications focused on sales, customer service, marketing automation, e-commerce, analytics, and application development;
integrating the virtual collaboration module with a second platform that supports concurrent videotelephony interactions among the plurality of users; and
integrating the virtual collaboration module with a third platform that offers a comprehensive and fully integrated stack of cloud applications and cloud platform services.

17. The non-transitory computer readable medium according to claim 15, wherein the hybrid cloud models include both on-premises data centers and public cloud.

18. The non-transitory computer readable medium according to claim 15, wherein the instructions, when executed, cause the processor to further perform the following:
hosting the virtual collaboration module onto a public cloud;
implementing scalable cloud infrastructure, load balancing, and distributed databases;
allowing access to the virtual collaboration module to a plurality of users;
integrating the virtual collaboration module with the scalable cloud infrastructure, load balancing, and the distributed databases; and
executing transactions, in response to integrating, among the plurality of users to process a plurality of documents and concurrent interactions.

19. The non-transitory computer readable medium according to claim 18, wherein the instructions, when executed, cause the processor to further perform the following:
implementing an encryption algorithm for data transmission and storage associated with the transactions; and
implementing a role-based access control algorithm in allowing the plurality of users to access the virtual collaboration module to protect user privacy and prevent unauthorized access.

20. The non-transitory computer readable medium according to claim 15, wherein the instructions, when executed, cause the processor to further perform the following:
implementing the virtual collaboration module with a first platform configured for file transferring capabilities allowing users to attach documents to chats; and allowing all parties to keep digital records of their communication and documents; and
integrating the virtual collaboration module with a cloud storage solutions or implementing a custom document repository for allowing indexing and utilizing search functionalities.
